(19) United States
(12) Patent Application Publication
(10) Pub. No.: US 2024/0179704 A1
(43) Pub. Date: May 30, 2024

(54) BASE STATION APPARATUS, TERMINAL APPARATUS, COMMUNICATION METHOD, AND COMPUTER-READABLE STORAGE MEDIUM FOR REDUCING LATENCY IN WIRELESS COMMUNICATION

(71) Applicant: KDDI CORPORATION, Tokyo (JP)

(72) Inventors: Masahito UMEHARA, Tokyo (JP); Masaya SHIBAYAMA, Tokyo (JP)

(21) Appl. No.: 18/435,625

(22) Filed: Feb. 7, 2024

Related U.S. Application Data
(63) Continuation of application No. PCT/JP22/25725, filed on Jun. 28, 2022.

(30) Foreign Application Priority Data
Sep. 21, 2021 (JP) 2021-153296

(51) Int. Cl. H04W 72/1268; H04L 5/00; H04W 72/23

(52) U.S. Cl. CPC H04W 72/1268; H04L 5/0048; H04W 72/23

(57) ABSTRACT

A base station apparatus notifies a terminal apparatus connected to or trying to establish a connection with the base station apparatus of information indicating a physical uplink control channel (PUCCH) format that can be used to transmit a scheduling request and can include information indicating a communication type, selects a type of grant to transmit to the terminal apparatus from a plurality of types of grants on a basis of a communication type indicated in the scheduling request received from the terminal apparatus via the PUCCH format, and transmits the selected type of grant to the terminal apparatus as a response to the scheduling request.

### CROSS-REFERENCE TO RELATED APPLICATION(S)

This application is a continuation of International Patent Application No. PCT/JP2022/025725 filed on Jun. 28, 2022, which claims priority to and the benefit of Japanese Patent Application No. 2021-153296 filed on Sep. 21, 2021, the entire disclosures of which are incorporated herein by reference.

### BACKGROUND OF THE INVENTION

### Field of the Invention

The present invention relates to a technique for reducing latency in wireless communications in a cellular communication system.

### Description of the Related Art

There is a demand for low-latency communication in cellular communication systems, and studies are being conducted in the 3rd Generation Partnership Project (3GPP (registered trademark)) into techniques for achieving ultra-reliable and low latency communications (URLLC). The present invention can provide a technique for reducing latency in wireless communications in a cellular communication system.

### SUMMARY OF THE INVENTION

According to one aspect of the present invention, there is provided a base station apparatus comprising: one or more processors; and one or more memories that stores a computer-readable instruction for causing, when executed by the one or more processors, the one or more processors to function as: a notifying unit configured to notify a terminal apparatus connected to or trying to establish a connection with the base station apparatus of information indicating a physical uplink control channel (PUCCH) format that can be used to transmit a scheduling request and can include information indicating a communication type; a selecting unit configured to select a type of grant to transmit to the terminal apparatus from a plurality of types of grants on a basis of a communication type indicated in the scheduling request received from the terminal apparatus via the PUCCH format; and a transmitting unit configured to transmit the selected type of grant to the terminal apparatus as a response to the scheduling request.

According to one aspect of the present invention, there is provided a terminal apparatus comprising: one or more processors; and one or more memories that stores a computer-readable instruction for causing, when executed by the one or more processors, the one or more processors to function as: an obtaining unit configured to obtain, from a connected or trying to connect base station apparatus, information indicating a physical uplink control channel (PUCCH) format that can be used to transmit a scheduling request and can include information indicating a communication type; and a communicating unit configured to transmit, to the base station apparatus, information indicating a communication type needed when transmitting a signal to the base station apparatus by including the information in the scheduling request that uses the PUCCH format, receive a grant selected from a plurality of types of grants by the base station apparatus as a response to the scheduling request, and transmit a signal to the base station apparatus on a basis of the grant.

Further features of the present invention will become apparent from the following description of exemplary embodiments with reference to the attached drawings.

### BRIEF DESCRIPTION OF THE DRAWINGS

FIG. 1 is a diagram illustrating a configuration example of a wireless communication system.

FIG. 2 is a diagram illustrating a hardware configuration example of a base station apparatus and a terminal apparatus.

FIG. 3 is a diagram illustrating a functional configuration example of the base station apparatus.

FIG. 4 is a diagram illustrating a functional configuration example of the terminal apparatus.

FIG. 5 is a diagram illustrating an example of the flow of processing executed by the wireless communication system.

FIG. 6 is a diagram illustrating an example of the flow of processing executed by the wireless communication system.

### DESCRIPTION OF THE EMBODIMENTS

Hereinafter, embodiments will be described in detail with reference to the attached drawings. Note, the following embodiments are not intended to limit the scope of the claimed invention, and limitation is not made to an invention that requires a combination of all features described in the embodiments. Two or more of the multiple features described in the embodiments may be combined as appropriate. Furthermore, the same reference numerals are given to the same or similar configurations, and redundant description thereof is omitted.

### Configuration of Communication System

FIG. 1 illustrates an example of the configuration of a wireless communication system according to the present embodiment. A wireless communication system is a wireless communication system compliant with the cellular wireless communication standard of the 5th generation (5G) as set by the 3rd Generation Partnership Project (3GPP (registered trademark)), for example. Note that this is an example and a different wireless communication system may be used. The wireless communication system, for example, includes a base station apparatus 101 and a terminal apparatus 102. Note that in the example of FIG. 1, only a small number of base station apparatuses and terminal apparatuses are illustrated to simplify the description, but naturally more base station apparatuses and terminal apparatuses may exist.

In the present wireless communication system, time division duplex (TDD) is used in the communications between the base station apparatus 101 and the terminal apparatus 102. In TDD, the common frequency resources are divided into time slots/sub-frames, and the plurality of time slots/sub-frames are each allocated for either uplink (link in the direction from the terminal apparatus 102 to the base station apparatus 101) or downlink (link in the direction from the base station apparatus 101 to the terminal apparatus 102). This allocation is compatible with long-term evolution (LTE) and TDD configuration of 5G.

In a cellular communication system, to control communications, a mechanism exists that uses a combination of downlink communication and uplink communication, and the communication of these combinations may be performed a plurality of times. When TDD is used, for example, after a downlink communication is performed with a downlink time slot, uplink communication cannot be performed until an uplink time slot arrives. This extends the amount of time taken until the communication is complete for this control. For example, in a case where user data for transmitting is generated, the terminal apparatus 102 transmits a scheduling request (SR) to the base station apparatus 101. Here, in a case where the time slot is allocated for downlink at the time when SR transmission become necessary, the terminal apparatus 102 has to wait for the time slot allocated for uplink to arrive. Then, after the terminal apparatus 102 transmits the SR using a time slot allocated for uplink, a grant for user data for uplink from the base station apparatus 101 is received with a downlink, and thereafter user data is transmitted. On the other hand, since the base station apparatus 101 decides what amount of frequency/time resources to allocate for the terminal apparatus 102 of the SR transmission source, when a time slot allocated for downlink arrives, instead of a grant for user data being immediately transmitted, a grant for a buffer status report (BSR) is transmitted to the terminal apparatus 102. In other words, the base station apparatus 101 transmits a grant including information designating the frequency/time resources for transmitting the BSR after the SR is received. Then, when the grant including the frequency/time resources allocation is received, the terminal apparatus 102 waits for an uplink time slot to arrive and transmits the BSR to the base station apparatus 101 with the allocated frequency/time resources. When the BSR is received, the base station apparatus 101 waits for a downlink time slot to arrive, allocates an amount of frequency/time resources to the terminal apparatus 102 based on the information reported by the BSR, and transmits a grant for transmitting user data to the terminal apparatus 102. When the terminal apparatus 102 receives the grant, the terminal apparatus 102 becomes able to transmit user data.

Here, with TDD, for example, a certain guard time needs to be provided when switching from a downlink time slot to an uplink time slot, and as a result, frequent switching between an uplink time slot and a downlink time slot may cause deterioration in the frequency utilization efficiency. Thus, after communication using an uplink time slot is performed, a certain amount of time is required until the next uplink time slot arrives. Accordingly, in a case where a signal is transmitted with an uplink, a signal is transmitted with a downlink in response to this signal, and a signal is further transmitted with an uplink in response to the downlink signal, since two uplink signals are transmitted, an transmission opportunity for an uplink must be waited for twice, requiring a certain amount of time.

As described above, with a known communication process, for preparation to transmit user data via uplink, a round trip of uplink communication and downlink communication, specifically, SR transmission and reception of a grant for BSR and BSR transmission and reception of a grant for user data, occurs twice. Thus, transmission preparation from when an SR is transmitted to when the user data is actually transmitted may take a long time, making the real time transmission of data from the terminal apparatus 102 difficult. In light of this, the present embodiment provides a method for reducing the amount of time taken to complete communication preparation.

In the present embodiment, the grant for BSR and the grant for user data are permitted to be transmitted and received together at a communication opportunity of a series of downlinks, and in a similar manner, the BSR and the user data are permitted to be transmitted and received together at a communication opportunity of a series of uplinks. For example, the base station apparatus 101, while transmitting a grant for BSR may transmit a grant for user data to the terminal apparatus 102 before the BSR is received. Note that the base station apparatus 101 may be configured to transmit a grant for BSR and a grant for user data together by transmitting a single grant. Also, in a case where the user data being a certain size is known in advance, the base station apparatus 101 may omit the grant for BSR and the reception of BSR. In this manner, at the next communication opportunity after a series of downlinks is communicated after transmitting and receiving SR, the user data can be exchanged. This can reduce the amount of time taken from when user data is generated to when transmitted. Note that the processing may be executed only in a case where the communication type (service type) is a predetermined type that requires a real-time element, and in the case of the communication using other types, as per known techniques, a grant for user data is issued after the grant for BSR and the exchange of BSR. In this manner, regarding communication with an emphasis on a real-time element, user data can be swiftly exchanged, and regarding communication without an emphasis on a real-time element, preparation processing to identify the size of the data to be transmitted can be executed and the appropriate amount of frequency/time resources can be identified and allocated.

In the present embodiment, for performing such a communication process, a physical uplink control channel (PUCCH) format that can be used in SR transmission and can include information enabling the communication type to be identified is newly defined. In other words, in a 5th Generation (5G) cellular communication system, a plurality of PUCCH formats are already defined and one of them can be used in SR transmission. However, in addition to this, a PUCCH format for an SR according to information indicating the communication type is newly defined. Herein, this PUCCH format is referred to as “PUCCH format X”. By using PUCCH format X, the terminal apparatus 102 according to the present embodiment can be set by the base station apparatus 101 to enable an SR including information (for example, a service identifier) that enables the communication type to be identified to be transmitted.

In the present embodiment, a setting for enabling the use of PUCCH format X is sent from the base station apparatus 101 that supports the communication process described above to the terminal apparatus 102 connected to the base station apparatus 101 or trying to establish a connection with the base station apparatus 101. The PUCCH format X setting is, for example, sent from the base station apparatus 101 to the terminal apparatus 102 via a radio resource control (RRC) message. For example, via a RRC reconfiguration message, the PUCCH format X setting may be sent from the base station apparatus 101 to the terminal apparatus 102. Note that the base station apparatus 101 may not send the PUCCH format X setting to the terminal apparatus 102 if it does not support the PUCCH format X. Also, the base station apparatus 101 may send the PUCCH format X to a terminal apparatus broadcasting PUCCH format X usability via system information block (SIB) or the like. Note that the base station apparatus 101 may send the PUCCH format X to the terminal apparatus 102 together with another usable PUCCH format.

The terminal apparatus 102 uses the PUCCH format X on the basis of the PUCCH format X setting to enable SR transmission. In a case where user data needs to be transmitted, the terminal apparatus 102 includes information that enables the communication type to be identified, such as which communication service is supported by the user data communication, in the SR using the PUCCH format X and transmits this to the base station apparatus 101. For example, information that enables whether or not the communication type has high real-time element is included in the SR using the PUCCH format X and transmitted. Note that, regarding user data which permits the use of a known communication process to exchange a grant for user data after an exchange for BSR, the terminal apparatus 102 may use the PUCCH format X and transmit an SR including information relating to the type of communication which permits use of a known communication process to the base station apparatus 101. Also, regarding user data which permits use of a known communication process, for example, the terminal apparatus 102 may use a known PUCCH format to transmit an SR. As described above, the base station apparatus 101 may decide whether to transmit a grant for user data without waiting for the BSR to be received or whether to use a known communication process depending on the communication type included in the SR. Note that in a case where a grant for user data is transmitted without waiting for the BSR to be received, for example, the base station apparatus 101 may separately transmit a grant for BSR and user data or may collectively (as one message) transmit a grant for BSR and user data. In a case where the communication type (or a service identifier) requiring a real-time element is stored in advance and an SR for PUCCH format X indicating a communication type requiring a real-time element is received, the base station apparatus 101 may decide to transmit a grant for user data without waiting for the BSR to be received. On the other hand, in a case where an SR for PUCCH format X indicating a communication type not requiring a real-time element is received, the base station apparatus 101 may first transmit a grant for BSR, then, after the BSR is received, transmit a grant for user data. In other words, the base station apparatus 101 selects the type of grant on the basis of the communication type transmitted using PUCCH format X. Also, the base station apparatus 101 transmits a grant for the selected type to the terminal apparatus 102 as a response to the SR. Note that the information that enables the communication type to be identified may be a service identifier, for example, or may be information indicating communication quality such as permitted latency or the like. Also, a plurality of categories may be defined by communication quality, and information indicating a category may be used as the information that enables the communication type to be identified.

Note that as described above, based on the premise that a BSR will be transmitted, the base station apparatus 101 may transmit a grant for user data before the BSR is received in addition to a grant for BSR. However, no such limitation is intended. For example, alternatively or in addition to, the base station apparatus 101 may transmit a grant for user data without a BSR being transmitted (without a grant for BSR being transmitted). Note that, for example, information that enables whether or not the communication is a type where a predetermined size of user data to be transmitted is set may be included in an SR using PUCCH format X and transmitted. Accordingly, a BSR may not be transmitted for communication with user data of a predetermined size. Also, regardless of the size of the user data, the base station apparatus 101 may allocate a certain amount of frequency/time resources to the terminal apparatus 102 without using a BSR and transmit the initial user data using these frequency/time resources. In this case, together with the initial user data, the remaining data amount in the buffer may be sent to the base station apparatus 101, and the base station apparatus 101 may allocate frequency/time resources for the second transmission of the user data and onward on the basis of the data amount information.

As described above, the base station apparatus 101 may select the type of grant on the basis of the communication type. However, for example, the communication type may be selected depending on whether an SR using PUCCH format X is transmitted or whether a known PUCCH format is used. In other words, in a case where PUCCH format X is used, as described above, a grant for user data may be transmitted from the base station apparatus 101 to the terminal apparatus 102 in a state where the BSR is not transmitted. In this case, the communication type may not be indicated in the PUCCH format X. In other words, depending on which PUCCH format is used, the base station apparatus 101 may select to issue a grant for user data without waiting to the BSR to be received or omitting with BSR or to use a known communication process.

As described above, by preparing a new PUCCH format, the base station apparatus 101 can identify whether or not the communication being requested by the SR is a predetermined type of communication such as communication requiring a real-time element or the like. Also, the base station apparatus 101 can reduce the amount of time taken until preparation for communication is complete for the predetermined type of communication.

Hereinafter, a configuration example of the base station apparatus 101 and the terminal apparatus 102 that execute the processing described above and an example of the executed processing will be described.

### Apparatus Configuration

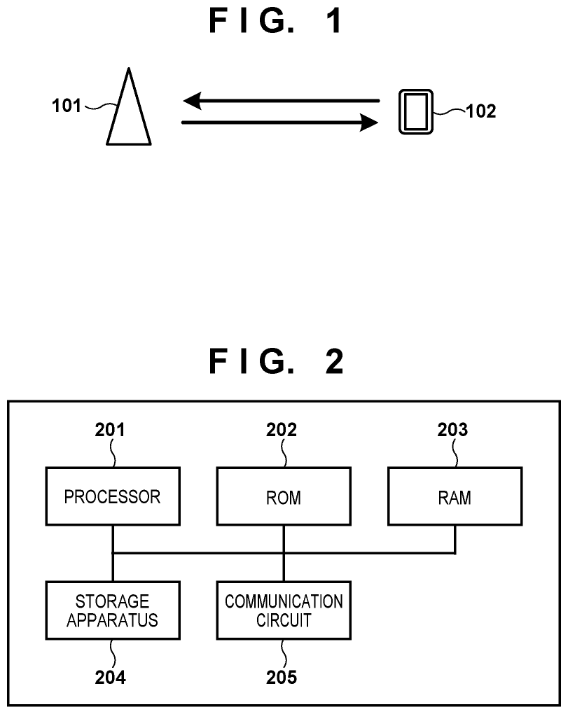

A hardware configuration example of the base station apparatus 101 and the terminal apparatus 102 will now be described using FIG. 2. The base station apparatus 101 and the terminal apparatus 102 include, for example, a processor 201, ROM 202, RAM 203, a storage apparatus 204, and a communication circuit 205. The processor 201 is a computer, such as a general-purpose central processing unit (CPU), an application specific integrated circuit (ASIC), or the like, including one or more processing circuits. By the processor 201 reading out and executing a program stored in the ROM 202 and the storage apparatus 204, the processing of the entire apparatus and the processing described above are executed. The ROM 202 is read-only memory that stores information, such as a program relating to processing executed by the base station apparatus 101 and the terminal apparatus 102, various parameters, and the like. The RAM 203 is random-access memory that functions as a work space when the processor 201 executes a program and temporary stores information. The storage apparatus 204 is constituted by a detachable external storage device, for example. The communication circuit 205 is constituted by a circuit for LTE or 5G wireless communication, for example. Note that in FIG. 2, only the single communication circuit 205 is illustrated, but the base station apparatus 101 and the terminal apparatus 102 may include a plurality of communication circuits. For example, the base station apparatus 101 and the terminal apparatus 102 may include wireless communication circuit and a shared antenna for LTE and 5G. Note that the base station apparatus 101 and the terminal apparatus 102 may separately include an antenna for LTE and an antenna for 5G. Also, the base station apparatus 101 may further include a wired communication circuit used when communicating with another base station apparatus or a core network node. Also, the terminal apparatus 102 may include a communication circuit for another wireless communication system such as wireless LAN. Note that the base station apparatus 101 and the terminal apparatus 102 may include separate communication circuits 205 for a plurality of usable frequency bands or may include common communication circuits 205 shared by two or more of the frequency bands.

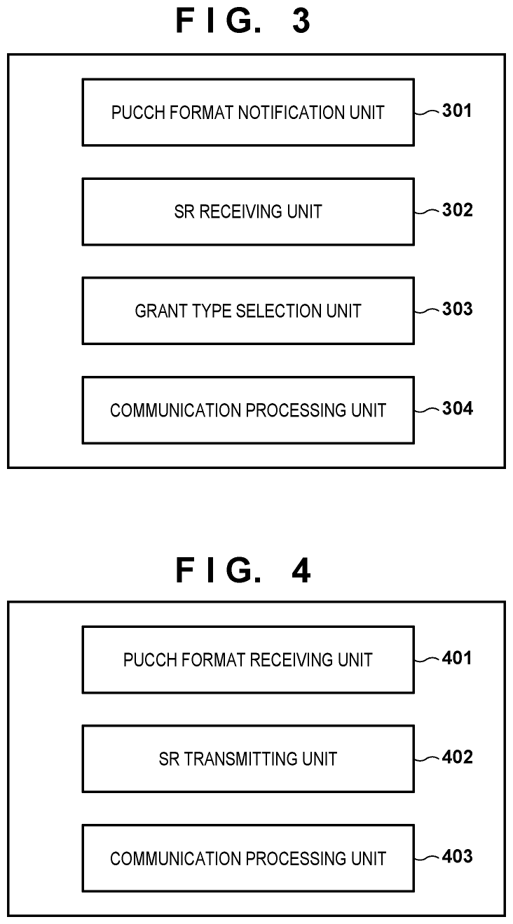

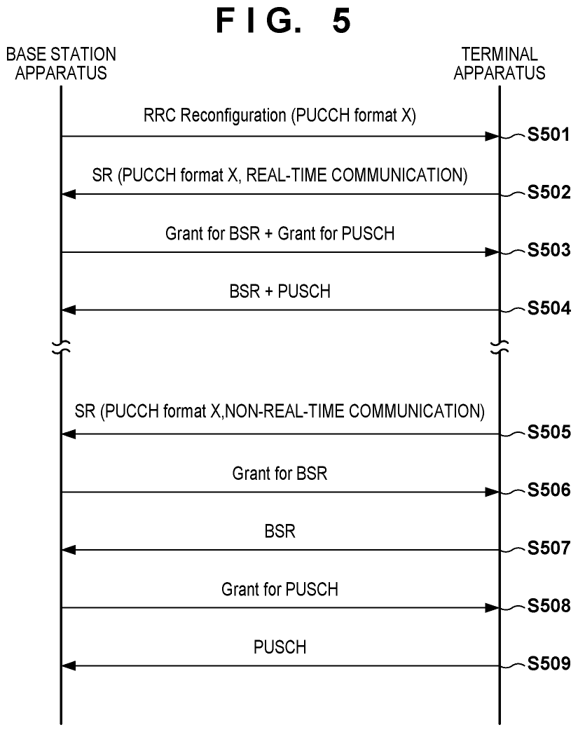

FIG. 3 is a diagram illustrating an example of the functional configuration of the base station apparatus 101. For example, the base station apparatus 101 includes a PUCCH format notification unit 301, a SR receiving unit 302, a grant type selection unit 303, and a communication processing unit 304. These functional units may be implemented, for example, by the processor 201 executing a program stored in the ROM 202 or the storage apparatus 204. Alternatively, one or more or all of the functions may be implemented by a dedicated piece of hardware. Note that the base station apparatus 101 naturally includes other typical base station apparatus functions not illustrated in FIG. 3.

The PUCCH format notification unit 301 notifies the terminal apparatus 102 of a message for setting to enable an SR to be transmitted using PUCCH format X. The message is an RRC message, for example. Also, the PUCCH format notification unit 301 may notify the surrounding terminal apparatuses 102 that the base station apparatus 101 can use (supports) PUCCH format X using a notification signal such as SIB or the like. The SR receiving unit 302 receives a scheduling request (SR) from the terminal apparatus 102. The SR receiving unit 302 identifies that PUCCH format used in the SR transmission, for example. Also, the SR receiving unit 302 may identify the communication type of the user data associated with the SR when the PUCCH format X is used.

In a case where an SR is received via a known PUCCH format, the grant type selection unit 303 decides to use a known communication process and first transmits a BSR grant. Thereafter, in response to a BSR being received, the grant type selection unit 303 decides to transmit a grant for user data with allocated frequency/time resources of an amount corresponding to the data amount indicated in the BSR. Also, in a case where an SR is received via the PUCCH format X, for example, the grant type selection unit 303 may select to transmit a BSR grant together with transmitting a grant for user data without waiting for the BSR to be received or to transmit a grant for user data while omitting the BSR. Also, even in a case where an SR is received via the PUCCH format X, for example, the grant type selection unit 303 may decide to use a known communication process depending on the communication type notified of in the PUCCH format X. The communication processing unit 304 executes a communication process for transmitting user data to the terminal apparatus 102 on the basis of the type of the grant selected by the grant type selection unit 303.

FIG. 4 is a diagram illustrating an example of the functional configuration of the terminal apparatus 102. The terminal apparatus 102, for example, includes a PUCCH format receiving unit 401, an SR transmitting unit 402, and a communication processing unit 403. These functional units may be implemented, for example, by the processor 201 executing a program stored in the ROM 202 or the storage apparatus 204. Alternatively, one or more or all of the functions may be implemented by a dedicated piece of hardware. Note that the terminal apparatus 102 naturally includes other typical terminal apparatus functions not illustrated in FIG. 4.

The PUCCH format receiving unit 401 receives a predetermined message from the base station apparatus 101 and obtains a setting to enable an SR to be transmitted using PUCCH format X. The predetermined message is an RRC message, for example. Also, the PUCCH format receiving unit 401 may receive a notification signal such as an SIB or the like including information indicating that the base station apparatus 101 can use (supports) the PUCCH format X. The SR transmitting unit 402 transmits a scheduling request (SR) to the base station apparatus 101. In the case of performing communication which requires a real-time element and requires a short amount of time from SR transmission to user data transmission, the SR transmitting unit 402 transmits an SR using PUCCH format X. Also, in the case of using PUCCH format X, the SR transmitting unit 402 may transmit an SR including information that enables the communication type to be identified.

The communication processing unit 403 performs communication according to a grant transmitted from the base station apparatus 101 in response to the SR transmitted by the SR transmitting unit 402. For example, in a case where the base station apparatus 101 decides to use a known communication method, initially a BSR grant is received via a downlink communication opportunity, and, in response to the grant, the communication processing unit 403 transmits the BSR using the frequency/time resources indicated in the grant via a subsequent uplink communication opportunity. Also, when a grant for user data is received via a subsequent downlink communication opportunity, the communication processing unit 403 transmits user data using the frequency/time resources indicated in the grant via a subsequent uplink communication opportunity. On the other hand, in a case where a grant for BSR and user data is received via one downlink communication opportunity, the communication processing unit 403 transmits the BSR and the user data via a subsequent uplink communication opportunity. Also, in a case where a grant for user data is received without receiving a grant for BSR as a response to the SR, the communication processing unit 403 may transmit the user data without transmitting the BSR via a subsequent uplink communication opportunity.

### Processing Flow

Next, an example of the flow of the processing executed by the wireless communication system will be described. Note that with the processing described below, the various types of modifications described above can be used. However, herein, these modified examples are not described.

In the wireless communication system, first, the base station apparatus 101 transmits an RRC message including a setting for PUCCH format X to the terminal apparatus 102 that is connected or trying to establish a connection, and the terminal apparatus 102 is enabled to use the PUCCH format X (step S501).

Then, the terminal apparatus 102 transmits an SR in response to user data to be transmitted being generated (step S502). Here, the terminal apparatus 102 transmits the SR including information that enables the communication type required for real-time communication using PUCCH format X. When the SR relating to the communication type requiring real-time communication is received, to reduce the amount of time for communication preparation, the base station apparatus 101 transmits a grant for BSR and further transmits a grant (grant for PUSCH) for user data before the BSR is received (step S503). Note that PUSCH is a physical uplink shared channel, and user data is transmitted using PUSCH. Also, the base station apparatus 101 may transmit the grant for BSR and the grant for user data via a single message or may transmit these grants via separate messages. When the grant for BSR and the grant for user data are received, the terminal apparatus 102 transmits the BSR and the user data via an uplink transmission opportunity using the frequency/time resources designated for each (step S504). Note that this example is of a case where a BSR is transmitted, but a grant for BSR and BSR transmission may be omitted.

In a case where the terminal apparatus 102 transmits an SR including information that enables a communication type that does not require real-time communication to be identified (step S505), for example, the base station apparatus 101 may determine that reducing the communication preparation time is not necessary. In this case, the base station apparatus 101 decides to use a known communication process and first transmits a grant for BSR (step S506). Then, after the BSR is received from the terminal apparatus 102 (step S507), the base station apparatus 101 transmits a grant for user data (step S508). Then, the terminal apparatus 102 transmits the user data on the basis of the grant (step S509).

In this manner, depending on the communication type indicated in the SR, the base station apparatus 101 can selectively use a grant for reducing communication preparation and a grant for known communication preparation. Note that the example described above is a case in which the communication type information is sorted according to whether or not real-time communication is needed. However, no such limitation is intended. In other words, any criteria may be used to select whether or not to reduce the communication preparation.

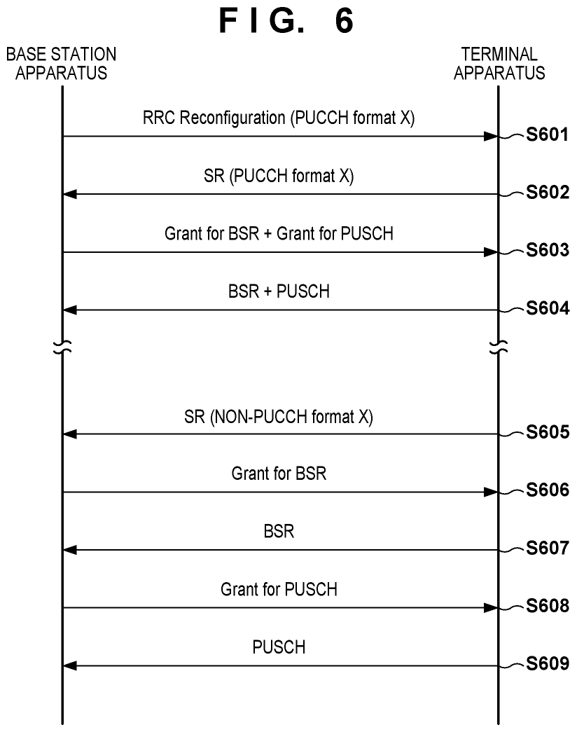

Also, in a case where the terminal apparatus 102 transmits an SR using PUCCH format X, a grant for reducing communication preparation may be used. A processing example of this case is illustrated in FIG. 6. In the present processing example, first, as in step S501, the terminal apparatus 102 is made able to use PUCCH format X (step S601). Thereafter, in a case where the communication preparation is to be reduced, such as when transmitting user data that requires real-time communication, for example, the terminal apparatus 102 may transmit an SR using PUCCH format X (step S602). To reduce the communication preparation time, the base station apparatus 101, in response to receiving an SR using PUCCH format X, transmits a grant for BSR and a grant for user data together during a single downlink interval (step S603). Then, the terminal apparatus 102 transmits the BSR and user data using the frequency/time resources designated in the grants on the basis of the grants (step S604).

In a case where the communication preparation does not need to be reduced, such as when transmitting user data that does not require real-time communication, for example, the terminal apparatus 102 may transmit an SR using a PUCCH format different from PUCCH format X (step S605). In this case, the base station apparatus 101 may determine that communication preparation time reduction is not necessary. In this case, the base station apparatus 101 decides to use a known communication process and first transmits a grant for BSR (step S606). Then, after the BSR is received from the terminal apparatus 102 (step S607), the base station apparatus 101 transmits a grant for user data (step S608). Then, the terminal apparatus 102 transmits the user data on the basis of the grant (step S609).

In this manner, depending on whether or not PUCCH format X is used in the SR transmission, the base station apparatus 101 can selectively use a grant for reducing communication preparation and a grant for known communication preparation. Accordingly, the terminal apparatus 102 can determine whether or not communication preparation reduction is necessary and, on the basis of the determination result, can decide whether or not to use PUCCH format X. Note that in the example described above, whether or not real-time communication is necessary is used as criteria in order to decide whether or not communication preparation reduction is necessary. However, no such limitation is intended. In other words, any criteria may be used to decide whether or not communication preparation reduction is necessary.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions

What is claimed is:

1. A base station apparatus comprising:
one or more processors; and
one or more memories that stores a computer-readable instruction for causing, when executed by the one or more processors, the one or more processors to function as:
a notifying unit configured to notify a terminal apparatus connected to or trying to establish a connection with the base station apparatus of information indicating a physical uplink control channel (PUCCH) format that can be used to transmit a scheduling request and can include information indicating a communication type;
a selecting unit configured to select a type of grant to transmit to the terminal apparatus from a plurality of types of grants on a basis of a communication type indicated in the scheduling request received from the terminal apparatus via the PUCCH format; and
a transmitting unit configured to transmit the selected type of grant to the terminal apparatus as a response to the scheduling request.

2. The base station apparatus according to claim 1, wherein the plurality of types of grants includes a grant for permitting transmission of user data without transmitting a buffer status report.

3. The base station apparatus according to claim 1, wherein the plurality of types of grants includes a grant for causing a buffer status report to be transmitted and for causing user data to be transmitted without waiting for the buffer status report to be received.

4. The base station apparatus according to claim 3, wherein the transmitting unit transmits a grant for buffer status report and a grant for user data separately to the terminal apparatus.

5. The base station apparatus according to claim 3, wherein the transmitting unit transmits a grant for collectively permitting transmission of buffer status report and transmission of user data.

6. A terminal apparatus comprising:
one or more processors; and
one or more memories that stores a computer-readable instruction for causing, when executed by the one or more processors, the one or more processors to function as:
an obtaining unit configured to obtain, from a connected or trying to connect base station apparatus, information indicating a physical uplink control channel (PUCCH) format that can be used to transmit a scheduling request and can include information indicating a communication type; and
a communicating unit configured to transmit, to the base station apparatus, information indicating a communication type needed when transmitting a signal to the base station apparatus by including the information in the scheduling request that uses the PUCCH format, receive a grant selected from a plurality of types of grants by the base station apparatus as a response to the scheduling request, and transmit a signal to the base station apparatus on a basis of the grant.

7. The terminal apparatus according to claim 6, wherein
the plurality of types of grants includes a grant for permitting transmission of user data without transmission of a buffer status report.

8. The terminal apparatus according to claim 6, wherein
the plurality of types of grants includes a grant for causing a buffer status report to be transmitted and for causing user data to be transmitted without waiting for the buffer status report to be received.

9. A communication method executed by a base station apparatus comprising:
notifying a terminal apparatus connected to or trying to establish a connection with the base station apparatus of information indicating a physical uplink control channel (PUCCH) format that can be used to transmit a scheduling request and can include information indicating a communication type;
selecting a type of grant to transmit to the terminal apparatus from a plurality of types of grants on a basis of a communication type indicated in the scheduling request received from the terminal apparatus via the PUCCH format; and
transmitting the selected type of grant to the terminal apparatus as a response to the scheduling request.

10. A communication method executed by a terminal apparatus comprising:
obtaining, from a connected or trying to connect base station apparatus, information indicating a physical uplink control channel (PUCCH) format that can be used to transmit a scheduling request and can include information indicating a communication type;
transmitting, to the base station apparatus, information indicating a communication type needed when transmitting a signal to the base station apparatus included in the scheduling request using the PUCCH format;
receiving a grant selected from a plurality of types of grants by the base station apparatus as a response to the scheduling request; and
transmitting a signal to the base station apparatus on a basis of the grant.

11. A non-transitory computer-readable storage medium that stores a program for causing a computer provided in a base station apparatus to:
notify a terminal apparatus connected to or trying to establish a connection with the base station apparatus of information indicating a physical uplink control channel (PUCCH) format that can be used to transmit a scheduling request and can include information indicating a communication type;
select a type of grant to transmit to the terminal apparatus from a plurality of types of grants on a basis of a communication type indicated in the scheduling request received from the terminal apparatus via the PUCCH format; and
transmit the selected type of grant to the terminal apparatus as a response to the scheduling request.

12. A non-transitory computer-readable storage medium that stores a program for causing a computer provided in a terminal apparatus to:
obtain, from a connected or trying to connect base station apparatus, information indicating a physical uplink control channel (PUCCH) format that can be used to transmit a scheduling request and can include information indicating a communication type;
transmit, to the base station apparatus, information indicating a communication type needed when transmitting a signal to the base station apparatus included in the scheduling request using the PUCCH format;
receive a grant selected from a plurality of types of grants by the base station apparatus as a response to the scheduling request; and
transmit a signal to the base station apparatus on a basis of the grant.
